(19) United States
(12) Patent Application Publication
(10) Pub. No.: US 2024/0154451 A1
(43) Pub. Date: May 9, 2024

(54) BATTERY CHARGER TO SUPPORT MULTIPLE CHARGING CONFIGURATIONS

(71) Applicant: Lear Corporation, Southfield, MI (US)

(72) Inventors: Rafael JIMENEZ PINO, Valls (ES); Hector SARNAGO ANDIA, Olvega (Soria) (ES); Oscar LUCIA GIL, Zaragoza (ES); Pablo GAONA ROSANES, Valls (ES); Ruben MOLINA LLORENTE, Valls (ES); Antonio MARTINEZ PEREZ, Valls (ES)

(21) Appl. No.: 17/983,899

(22) Filed: Nov. 9, 2022

(51) Int. Cl. H02J 7/02; H02J 7/00; H02M 3/335; H02M 7/5387

(52) U.S. Cl. CPC H02J 7/02; H02J 7/0013; H02M 3/335; H02M 7/5387; H02J 2207/20

(57) ABSTRACT

In at least one embodiment a system including at least one switch, at least one transformer, a first active bridge and at least one controller. The at least one switch receives a first direct current (DC) input signal from a first DC charging station. The at least one transformer includes a primary side and a secondary side. The secondary side of the at least one transformer is connected to the at least one switch and transfers the first DC input signal. The first active bridge is positioned on the secondary side, the first active bridge generates a DC output signal that supplies one or more vehicle loads. The DC output signal is greater than the first DC input signal and the at least one controller programmed to activate the at least one switch in response to receiving the first DC input signal.

### TECHNICAL FIELD

Aspects disclosed herein generally relates to a battery charger that supports multiple charging configurations. These aspects and others will be discussed in more detail herein.

### BRIEF DESCRIPTION OF THE DRAWINGS

FIG. 1 depicts a system for supporting multiple charging voltages for vehicle charging in accordance with one embodiment; and

FIG. 2 depicts a system for supporting multiple charging configurations in accordance with one embodiment.

### DETAILED DESCRIPTION

Reference will now be made in detail to embodiments, examples of which are illustrated in the accompanying drawings. In the following detailed description, numerous specific details are set forth in order to provide a thorough understanding of the various described embodiments. However, it will be apparent to one of ordinary skill in the art that the various described embodiments may be practiced without these specific details. In other instances, well-known methods, procedures, components, circuits, and networks have not been described in detail so as not to unnecessarily obscure aspects of the embodiments.

It is to be understood that the disclosed embodiments are merely exemplary and that various and alternative forms are possible. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ embodiments according to the disclosure.

“One or more” and/or “at least one” includes a function being performed by one element, a function being performed by more than one element, e.g., in a distributed fashion, several functions being performed by one element, several functions being performed by several elements, or any combination of the above.

It will also be understood that, although the terms first, second, etc. are, in some instances, used herein to describe various elements, these elements should not be limited by these terms. These terms are only used to distinguish one element from another. For example, a first contact could be termed a second contact, and, similarly, a second contact could be termed a first contact, without departing from the scope of the various described embodiments. The first contact and the second contact are both contacts, but they are not the same contact.

The terminology used in the description of the various described embodiments herein is for the purpose of describing particular embodiments only and is not intended to be limiting. As used in the description of the various described embodiments and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

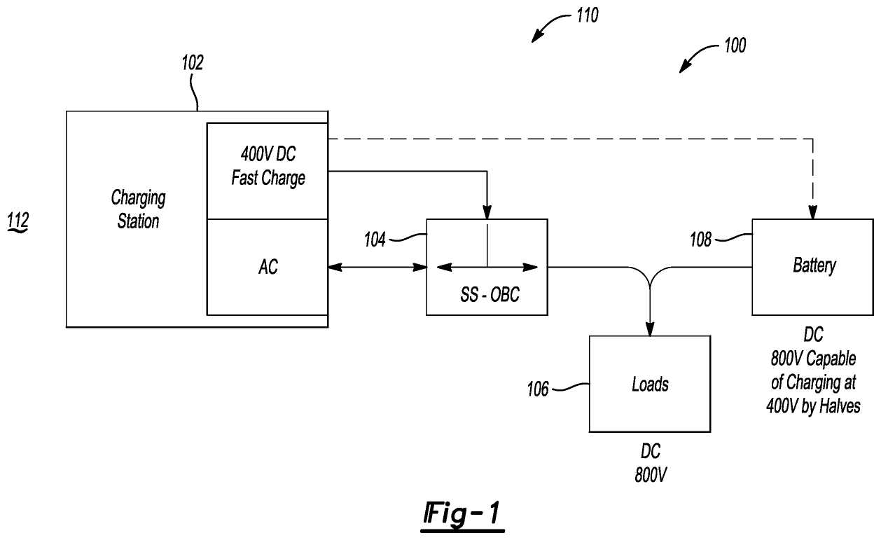

FIG. 1 depicts a system 100 for supporting multiple charging voltages for vehicle charging. The system 100 includes a charging station (or post) 102, an on-board charger (OBC) 104, one or more vehicle loads (“the loads”) 106, and one or more batteries (“the batteries”) 108. The on-board charger 104, the vehicle loads 106, and the batteries 108 may be positioned in a vehicle 110. In general, the vehicle 110 may be electrically coupled to the charging station 102 to at least one of power the loads 106 or charge the batteries 108. The vehicle 110 may receive power from the charging station 102 to one of charge the batteries 108 and/or power the loads 106.

The charging station 102 generally supports multiple charging modes such as, for example, a direct current (DC) charging mode (or DC fast charging mode) and an alternating current (AC) to DC charging mode. With the DC fast charging mode, the charging station 102 may provide a charging voltage of, for example, 400V to the batteries 108. In general, the AC to DC charging mode may provide a charging voltage of, for example, 800V to the loads 106. In the AC to DC charging mode, the charging station 102 transfers AC energy from a grid 112 (or mains supply) to the OBC 104. The OBC 104 converts the AC energy into DC energy to drive the loads 106.

The DC fast charging mode may correspond to the Tesla Supercharger®, Ionity Charger®, etc. In general, the DC fast charging mode is generally configured to transfer a higher amount of energy from the charging station 102 to the vehicle 110 than that of the AC to DC charging mode. The DC fast charging mode is generally faster than the AC to DC charging mode since the DC fast charging mode provides the same amount of energy and delivers such energy in less time than that of the AC to DC charging mode. For example, in the DC fast charging mode, more energy is transferred per unit of time (e.g., more energy is transferred per second). As shown in FIG. 1, when both the charging station 102 and the batteries 108 are compatible with one another. The charging station 102 may transfer energy directly to the batteries 108 of the vehicle 110 when the DC fast charging mode is employed. With respect to 400 to 800V direct charging, the batteries 108 may have the capability to rearrange itself (e.g., split in two 400V pack and reconnect in parallel) to enable 400V direct charging. In the AC to DC charging mode, the charging station 102 transfer energy directly to the OBC 104 which then transfers the energy also to the batteries 108 to charge the batteries. In this case, the OBC 104 transfers the energy or voltage to support, for example, 800V charging of the batteries 108.

In general, the OBC 104 may be compatible to facilitate both the DC fast charging mode and the AC to DC charging mode. As noted above in connection with the DC fast charging mode, when charging from the charge station 102, the DC voltage may be a voltage of up to 400V. However, vehicles in generally utilize, for example, 800V vehicle architectures for an efficiency increase. Thus, the vehicles may be compatible with both the 400V charging infrastructure for the DC fast charging mode and for the 800V infrastructure having 800V batteries which utilizes, for example, 2×400V high voltage (HV) battery strings. The vehicles may be reconfigurable with a HV relay matrix as 2×400V batteries that are in series with one another to achieve the 800V or 2×400V parallel connected for DC fast charge operation compatibility. The relay matrix for this purpose may be bulky and reduce reliability of the battery system (or batteries 108).

As noted above, the DC fast charging mode shortens the charge operation. During the DC fast charging mode with conventional systems, electronics for the OBC 104 may be deactivated. The DC charge process is managed directly with high power relays that are integrated inside the vehicle in any number of modules.

Original Equipment Manufacturers (OEMs) attempt to enable the 400V provided by the DC fast charging mode to be provided at the vehicle 110 with little to no functional penalty. Thus, in this regard, the same functionality shall be available either in AC to DC charging mode and the DC fast charging mode. To achieve compatibility in the sense of providing a single device that can handle energy transfer for the DC fast charging mode and the AC to DC charging mode, the vehicle load that operate at, for example, 800V are provided with a same operational range as when the vehicle 110 is in a driving mode (e.g., for a vehicle with an 800V HV battery configuration). Similarly, it may be desirable to provide a single device that can handle additional charging characteristics such a AC charging mode to charge electronic consumers (e.g., mobile devices, tablets, laptops, etc.) that are electrically coupled to the vehicle 110 for charging.

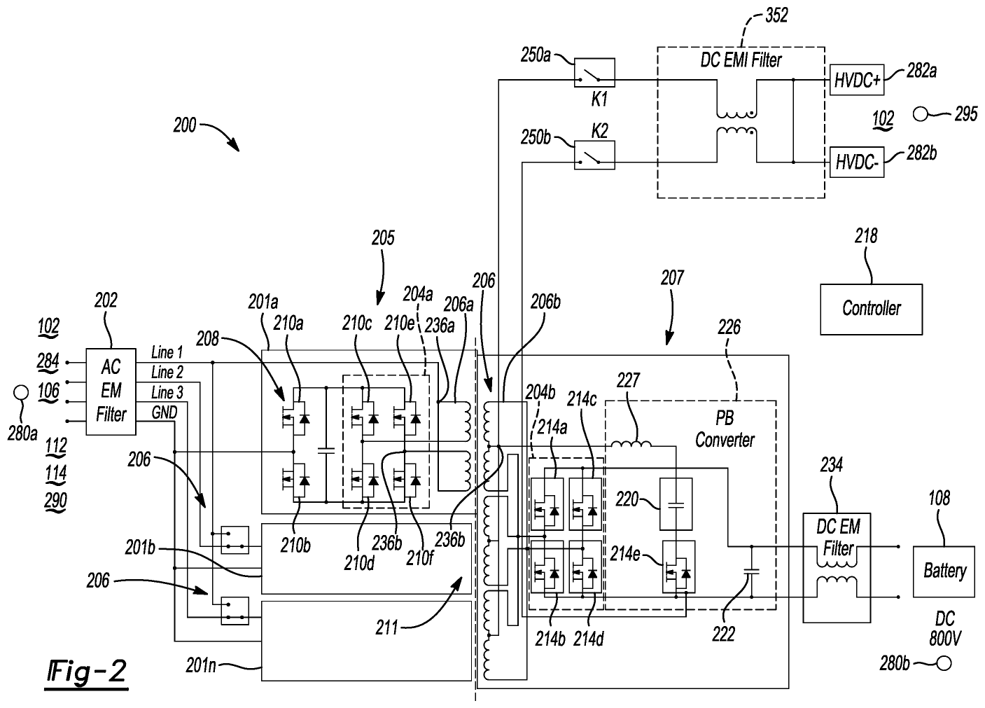

FIG. 2 depicts a system 200 for supporting multiple charging configurations in accordance with one embodiment. In one example, the system 200 may be implemented as the OBC 104 as noted in connection with FIG. 1. The system 200 generally includes a plurality of modular converters 201a-201n (or “201”). Each corresponding modular converter 201 includes a rectifying half bridge structure 208 (or rectifier 208) and dual active bridges (DAB) stages 204a, 204b. Each of the modular converters 201 also includes one transformer 206 (e.g., a single transformer 206 with two primary windings 206a (or primary-side transformer 206a) positioned on a primary side 205 and two or more secondary windings (or secondary-side transformer 206b) positioned on a secondary side 207, and the PB converter 226. In general, there is one transformer 206 per modular converter 201 and each transformer 206 includes a primary with two coils or windings 206a (with a middle point 236a) (or the two primary windings 206a) and a secondary with two coils or windings 206b (with a middle point (or center tap) 236b) (or the two secondary windings 206b). FIG. 2 illustrates the details for the modular converter 201a which includes the primary transformer 206a and the secondary transformer 206b and a number of other features. While FIG. 2 illustrates the additional modular converters 201b-201n, it is recognized that each of these modular converters 201b-201n include similar features to that depicted as shown in the modular converter 201a. It is recognized that the primary windings 206a is only illustrated for the modular converter 201a and is not illustrated for the remaining modular converters 201b-201n. Similarly, it is recognized that the secondary windings 206b is illustrated in FIG. 2 for all modular converters 201a-201n.

The system 200 includes a first filter 202 and a second filter 234. The first filter 202 is operably coupled to the primary side 205 of each converter 201. The second filter 234 is operably coupled to the secondary side 207 that is common to all converters 201. The first filter 202 may be an AC electromagnetic interference (EMI) filter used to comply with EMC (electromagnetic compatibility) standards. The second filter 234 may be a DC EMI filter used to ensure smooth output current supplied to the batteries 215. The second filter 234 may be implemented in a number of OBC designs for the automotive market. It is recognized the number of modular converters 201 implemented in the disclosed system 200 may vary based on the desired criteria of a particular implementation.

Each of the converters 201 includes a plurality of switches 210a-210f (“210”) (e.g., a first active bridge (or metal-oxide-semiconductor field-effect transistors (MOSFETS)) and a capacitor 212. The switches 210a-210b generally form a rectifier 208. The rectifier 208 is generally coupled to the charging station 102 to rectify an incoming AC input. The plurality of switches 210 and the capacitor 212 are operably coupled to the primary-side transformer 206a for each the modular converters 201. In operation, for example, in the AC to DC charging mode, the charging station 102 provides an AC input to the first filter 202. The grid 112 provides the AC input to the charging station 102. The first filter 202 provides a filtered AC output to the rectifier 208, which includes the switches 210a and 210b, and provides a rectified output voltage or current in response to the output provided by the first filter 202. The rectifier 208 provides the rectified output voltage to the primary side 205. One or more controllers 218 (hereafter “the controller 218”) controls the switches 210 to provide a requisite amount of rectified output current associated from the rectified output voltage from the rectifier 208 to generate a primary-side output voltage or current on the primary-side transformer 206a.

The switches 210c-210f (or first active bridge) on the primary side 205 receive the rectified output voltage/current from the rectifier 208. The controller 218 controls the operation of the primary-side power switch bridge (or the switches 210c-210f) to draw a requisite amount of rectified output current associated with the rectified output voltage from the rectifier 208 and generate therefrom a primary-side output voltage on primary-side transformer 206a. The controller 218 controls the switches 210a-210d to generate a secondary-side input voltage/current on the secondary-side 207 (or on the secondary-side transformer 206b).

The DAB stage 204b includes power switches 214a-214d (or a second active bridge or MOSFETs) that are positioned on the secondary side 207. The PB converter 226 includes a switch 214e, capacitors 220 and 222, and an inductor 227. Capacitor 222 is a bus capacitor that is used to decouple electrical devices on the PB converter 226. The PB converter 226 may provide energy transfer based on magnetic energy stored on the inductor 227 and electrical energy stored on the capacitor 222. This aspect may be controlled based on the manner in which the controller 218 controls the switches. The capacitor 220 is charged with the secondary side input voltage or current which supplements the main energy flow that flows from the primary side 205 to the secondary side 207. The capacitor 220 supplements the main energy flow to reduce or minimize the ripple of the output that is stored on the battery 215. The capacitor 220 of the PB converter 226 is coupled to the middle point 236b of the secondary-side transformer 206b on the secondary side 207 via the inductor 227. In one example, the output for the OBC 104 may be set to 800V. Given that the capacitor 220 is coupled through the inductor 227 to the middle point 236b of the transformer 206, the voltage of the capacitor 220 may be, for example, half of the voltage of the batteries 108 with a maximum in the range of 400V. The secondary side 207 provides the primary voltage output that is stored on the batteries 108, while the PB converter 226 reduces the ripple associated with the voltage output. The PB converter 226 draws a buffer current associated with a buffer voltage from the capacitor 220 which is provided to the batteries 108 via the second filter 234. The controller 218 controls the operation of the power switches 214a-214d.

As noted above, the power switches 214a-214d are on the secondary side 207 and switch 214e along with the capacitor 220. Thus, in this regard, a portion of the PB converter 226 (e.g., the switch 214e and the capacitor 220) is combined together with the switches 214a-214d (or the DAB stage 104b) on the secondary side 207. The PB converter 226 draws a requisite amount of buffer current associated with the buffer voltage and generates therefrom a targeted, battery voltage/current. The PB converter 226 generates the required current to eliminate a current ripple that may have a frequency of, for example, 100 to 120 Hz and provides a smooth DC current to the batteries 108. In one example, the PB converter 226 minimizes the current ripple on the energy provided by the secondary-side transformer 206b and the DAB stage 204b to deliver a targeted battery voltage/current to charge the batteries 108. As noted, above the PB converter 226 is combined with the secondary side 207 (e.g., the switches 214a-214d). The controller 218 employs a control strategy (and control blocks) which enables the control of the PB converter 226 to be integrated with control of the secondary side 207. One example of a control strategy is set forth in pending U.S. application Ser. No. 17/335,661 (“the '661 application”) entitled “APPARATUS FOR SINGLE STAGE ON-BOARD CHARGER WITH AN INTEGRATED PULSATING BUFFER CONTROL” as filed on Jun. 1, 2021, which is hereby incorporated by reference in its entirety. It is recognized the secondary side 207 includes the DAB stages 104b, the transformer secondary 106b, and the PB converter 226.

It is recognized that the OBC 104 may support multiple charging modes. For example, the OBC 104 is electrically coupled to the charging station 102 to support the DC fast charging mode and the AC DC charging mode as noted above. The OBC 104 may also support the AC discharging mode in which energy stored on the batteries 108 of the vehicle 110 is transferred back through the OBC 104 to charge consumer electronic devices 114 that are electrically coupled to the vehicle 110. In the AC discharging mode, the OBC 104 may or may not be electrically coupled to the charging station 102. The OBC 104 also includes a plurality of mode switches 250a-250b (e.g., relays) to selectively activate the various charging modes such as the DC fast charging mode, the AC DC charging mode, and the AC discharging mode. For example, the controller 218 selectively controls the mode switches 250a-250b to open and/or close to select the desired charging mode. The controller 218 detects the type of charging mode that is desired and controls the switches 250a-250b accordingly to enable the OBC 104 to provide the DC fast charging mode, the AC DC charging mode, or the AC discharging mode. For example, the controller 219 may include a supervisory microcontroller unit (MCU) that receives the charging operation mode (e.g., DC fast charging mode, AC to DC charging mode, or AC discharging mode) from a master controller (not shown) positioned on the vehicle 110. The master controller on the vehicle coordinates the charging mode with the infrastructure (e.g., AC or DC, current and voltage setpoints, etc.).

The mode switch 250a is coupled to middle point 236 on the secondary side 206b of the transformer 206. In general, by connecting the mode switch 250a to the middle point 236, this aspect permits the energy to flow towards a middle of the transformer 206 (e.g., 400V), as the OBC 104 as shown in FIG. 2 may be intended for an 800V HV battery, the middle point 236 provides half the HV voltage (e.g., 400V) of the batteries 108. With the energy present in the middle point 236 of the transformer 206, the OBC 104 may then transfer energy to the primary side 205 and to the secondary 207 (e.g., 800V) to supply the vehicle loads 106. A third filter 352 is coupled to the mode switches 250a-250b and operably couples the switches 250a-205b and the rest of the OBC 104 to the charging station 102. The third filter 352 may be a DC EMI filter and is used to ensure a smooth output current is supplied to the OBC 104 from the charging station 102. In general, the third filter 352 ensures the smooth is supplied to the OBC 104 from the charging station 102 in the DC fast charging mode.

Aspects related to the AC to DC charging mode will be discussed in more detail. For example, in the AC to DC charging mode, the controller 218 may deactivate the mode switches 250a and 250b, and energy flows in direction 280a and 280b as shown in FIG. 2. In this case, since the mode switches 250a and 250b are deactivated, energy is not provided at inputs 282a and 282b of the OBC 104 from the charging station 102 in the DC fast charging mode. In charging state of the AC to DC charging mode, the charging station 102 provides AC energy at inputs generally shown at 284 of the OBC 104. The energy passes through the primary side 205 to the secondary side 207 of the OBC 104 (e.g., from node 280a to node 280b). The secondary side 207 of the OBC 104 provides a charging voltage of, for example, 800V to charge the batteries 108.

In the AC discharging mode, energy flow from the batteries 108 through the secondary side 207 and to the primary side 205 (e.g., from node 280b to node 280a) back to the grid 112. The primary side 205 of the OBC 104 outputs an AC output that is provided to an outlet 290 positioned in the vehicle 110. In this case, a vehicle driver or occupant may electrically couple one or more AC based electronic devices (e.g., mobile device, laptop, tablet) to the outlet 290 to charge the AC based electronic devices with the AC output. The coupling of the AC based electronic devices to the outlet 290 of the vehicle 110 may be performed by first coupling the vehicle 110 to the grid 112 at a user's home or other establishment. Also in the AC discharging mode, the controller 218 deactivates the mode switches 250a and 250b. As noted above, since the mode switches 250a and 250b are deactivated, energy is not provided to node 295.

In the DC fast charging mode, the charging station 102 provides DC voltage to node 295. With the DC fast charging mode, the charging station 102 provides, for example, a DC charging voltage of 400V to the OBC 104. It is recognized that OBCs may need to be compatible to support the DC fast charging mode, the AC to DC charging mode, and the AC discharging mode.

One trend with vehicles may involve providing 800V based vehicle architectures for an efficiency increase. Such vehicles must be compatible with the 400V charging infrastructure (e.g., DC fast charging mode). Thus, to satisfy this requirement, an 800V HV battery design may include 2×400V HV battery strings that may be reconfigurable with a HV relay matrix as a 2×400V series connection to achieve the 800V or a 2×400V parallel connection for the DC fast charging operation compatibility depending on the vehicle use mode.

The DC fast charging mode provides for a shorter charging operation. In one example, charging power may be provided of up to 350 kW and possibly more. In some embodiments in which the OBC is not capable of supporting the DC fast charging mode, the OBC may be deactivated since the DC charge process is managed directly with high power relays that can be integrated inside the vehicle in many controllers or modules (e.g., standalone controller, relays integrated within fly battery pack, etc.). OEMs seek to resolve the 400V compatibility issue at no functional penalty for the vehicle owner to ensure that the same functionality will be available either in the AC to DC charging mode and in DC fast charging mode. With conventional systems, when the batteries 108 are arranged as 2×400V batteries that are in parallel with one another, an 800V based vehicle load may not be activated and a bi-directional OBC may not be configured to provide 800V from the batteries 108 to supply external loads. The system 200 generally overcomes these limitations as the disclosed OBC 104 supports the DC fast charging mode, the AC to DC charging mode, and the AC discharging mode. Vehicles having 800V based pure loads are fed with the same operational range as when vehicle is in driving mode (e.g., 800V HV battery configuration) and the AC outlet for the AC discharging mode should be available for domestic devices supply. It is recognized that the AC discharging mode not only includes energy being transferred (e.g., 800V) from the batteries 108 to the outlet 290 (e.g., energy transferred from the node 280b to node 280a), but also includes the OBC 104 enabling energy provided by the charging station 102 from the node 295 to the outlet 290 (or to the node 280a).

The driver or occupant of the vehicle 110 may electrically couple the vehicle 110 to the charging station 102 to initiate the DC fast charging mode. In response, the controller 218 initiates a handshake sequence to perform an electrical integrity test and receive voltage and current setpoints that are deemed suitable for the batteries 108. In response to the controller 218 detecting that the vehicle 110 entering into the DC fast charging mode via electrical connection to the charging station 102, the controller 218 activates (or closes) the mode switches 250a and 250b. As noted above, the mode switch 250a is coupled directly to the middle point 236b of the secondary-side transformer 206b). Therefore, during the DC fast charging mode, energy is transferred from node 295 to the nodes 280a and 280b. In reference to the transfer of energy from the node 295 to the node 280b, the controller 218 controls the power switches 214a-214d (or the second active bridge) to boost the voltage being received from the charging station (e.g., 400V) to a boosted voltage of, for example, 800V that is used to power loads 106 in the vehicle 110. The power loads 106 may include a PTC heater, a climate compressor, HV/LV DC/DC converter, etc. For example, the controller 218 regulates the DC voltage as provided in the DC fast charging mode to adjust the voltage output (e.g., 50% which generates, for example, a boosted DC voltage that is 2× the input voltage) at the middle point 236b of the secondary transformer 206b. It is recognized that different boosted voltages may be provided by modulating the input DC voltages provided by the charging station 102. During the DC fast charging mode, the PB converter 226 is disabled and there may not be any need for active filtering on an AC component as the input is DC power.

In the AC discharging mode (e.g., the vehicle 110 provides AC energy to the consumer electronic devices 114), energy is transferred from the node 295 to the node 280a during the DC fast charging mode. As noted above, the controller 218 activates (or closes) the mode switches 250a and 250b in the DC fast charging mode to receive the charging voltage (e.g., 400V) from the charging station 102. The controller 210 also activates (i.e., high frequency switching) the power switches 214a-214d (or the second active bridge) to excite the transformer 206 for transferring energy from the secondary side 207 to the primary side 205. The controller 210 controls the switching frequency of the switches 210c-210f (e.g., a first active bridge) to regulate the transfer of the AC energy to the consumer electronic devices 114.

In general, when the controller 218 activates or excites the switches 210a-210f in the AC discharging mode, the outlet 290 is energized even if no electronic devices 114 are connected to the outlet 290. The controller 218 executes a voltage control loop that selectively activates the switches 210a-210f to provide a domestic voltage (e.g., 220/110Vac 50/60 Hz) on the socket or outlet 290. If a load is connected to the outlet 290 and starts consuming current, the controller 218 executes a current control loop to selectively activate the switches 210a-210f in accordance to a regulated a shifting duty cycle between the primary side 205 and secondary side 207 to transfer the requested power to the outlet 290. One example of the control loop is set forth the '661 application as noted above. The OBC 104 is capable of supporting, for example, vehicle to everything (V2X) and 400-800 V DC/DC conversion with a single OBC 800V variant without additional cost. The OBC 104 may also optimize weight and overall packaging size while providing enhanced functionality such as, for example, the 400 to 800 V fast charging capability in the DC fast charging mode in addition to enabling full 800V functionality in the vehicle 110 (e.g., the batteries 108 are not changed into 2×400V parallel packs).

Item 1: In one embodiment, the present disclosure provides a system including at least one switch, at least one transformer, and a first active bridge. The at least one switch receives a first direct current (DC) input signal from a first DC charging station. The at least one transformer includes a primary side and a secondary side, the secondary side of the at least one transformer connected to the at least one switch and transferring the first DC input signal. The first active bridge is positioned on the secondary side, the first active bridge generating a DC output signal, and the DC output signal supplies one or more vehicle loads. The DC output signal is greater than the first DC input signal. The at least one controller is programmed to activate the at least one switch in response to receiving the first DC input signal.

Item 2: In another embodiment, the present disclosure provides the system of item 1, wherein the at least one switch is coupled to a center tap of the at least one transformer.

Item 3: In another embodiment, the system of any of the preceding items, wherein the DC output signal is at least two times the voltage of the first DC input signal.

Item 4: In another embodiment, the system of any of the preceding items further comprising a pulsating buffer (PB) converter interfacing with the first active bridge on the secondary side, the PB converter enabling AC to DC charging, wherein the PB converter is deactivated in response to the at least one switch receiving the first DC input signal from the first DC charging station.

Item 5: In another embodiment, the system of any of the preceding items further comprising a second active bridge positioned on the primary side of the transformer, the second active bridge, in response to at least one switch being activated and the first active bridge being activated by the at least one controller, providing a first AC output powering one or more AC based electronic devices coupled to a vehicle.

Item 6: In another embodiment, the system of any of the preceding items further comprising a second active bridge positioned on the primary side of the transformer, the second active bridge provides a first voltage signal based on an input voltage signal from a mains supply of an electrical grid.

Item 7: In another embodiment, the system of any of the preceding items, wherein the at least one controller is further programmed to deactivate the at least one switch in response to receiving the input voltage signal from the mains supply.

Item 8: In another embodiment, the system of any of the preceding items, wherein the first active bridge provides a second voltage signal for storage on one or more batteries in response to the first voltage signal.

Item 9: In another embodiment, the system of any of the preceding items further comprising a pulsating buffer (PB) converter to interface with the first active bridge, the PB converter modifying the second voltage signal.

Item 10: In another embodiment, the present disclosure provides a system including at least one switch, at least one transformer, and a first active bridge. The at least one switch receives a first direct current (DC) input signal from a first DC charging station. The at least one transformer including a first side and a second side, the second side of the at least one transformer connected to the at least one switch and transferring the first DC input signal. The first active bridge is positioned on the second side, the first active bridge generating a DC output signal after increasing the first DC input signal and the DC output signal supplying one or more vehicle loads. The second active bridge is positioned on the first side of the transformer and providing a first AC output signal based on the first DC input signal. The at least one controller is programmed to activate the at least one switch in response to receiving the first DC input signal.

Item 11: In another embodiment, the system of item 10, wherein the at least one switch is coupled to a center tap of the at least one transformer.

Item 12: In another embodiment, the system of any of the preceding items, wherein the DC output signal is at least two times the voltage of the first DC input signal.

Item 13: In another embodiment, the system of any of the preceding items further comprising a pulsating buffer (PB) converter interfacing with the first active bridge on the second side, the PB converter enabling AC to DC charging, wherein the PB converter is deactivated in response to the at least one switch receiving the first DC input signal from the first DC charging station.

Item 14: In another embodiment, the system of any of the preceding items, wherein the second active bridge, in response to at least one switch being activated and the first active bridge being activated by the at least one controller, providing the first AC output signal powering one or more AC based electronic devices coupled to a vehicle.

Item 15: In another embodiment, the system of any of the preceding items, wherein the second active bridge, based on an input voltage signal from a mains supply of an electrical grid, provides a first voltage signal.

Item 16: In another embodiment, the system of any of the preceding items, wherein the at least one controller is further programmed to deactivate the at least one switch in response to receiving the input voltage signal from the mains supply.

Item 17: In another embodiment, the system of any of the preceding items, wherein the first active bridge, in response to the first voltage signal, provides a second voltage signal for storage on one or more batteries.

Item 18: In another embodiment, the system of any of the preceding items further comprising a pulsating buffer (PB) converter to interface with the first active bridge, the PB converter modifying the second voltage signal.

Item 19: In another embodiment, a system including at least one switch, at least one transformer, a first active bridge, and a second active bridge. The at least one switch receives a first direct current (DC) input signal from a first DC charging station. The at least one transformer, comprising a primary side and a secondary side, the secondary side of the at least one transformer is connected to the at least one switch and transferring the first DC input signal. The first active bridge is positioned on the secondary side, the first active bridge increasing the transferred first DC input signal to generate a DC output signal (800V), and the DC output signal supplying one or more loads in a vehicle. The second active bridge is positioned on the first side of the transformer. The second active bridge provides a first AC output and powers one or more AC based electronic devices coupled to a vehicle in response to the first active bridge generating the DC output signal.

Item 20: In another embodiment, the system of any of the preceding items further comprising at least one controller programmed to activate the at least one switch in response to receiving the first DC input signal.

It is recognized that the controllers as disclosed herein may include various processors, integrated circuits, memory devices (e.g., FLASH, random access memory (RAM), read only memory (ROM), electrically programmable read only memory (EPROM), electrically erasable programmable read only memory (EEPROM), or other suitable variants thereof), and software which co-act with one another to perform operation(s) disclosed herein. In addition, such controllers as disclosed utilizes one or more processors to execute a computer-program that is embodied in a non-transitory computer readable medium that is programmed to perform any number of the functions as disclosed. Further, the controller(s) as provided herein includes a housing and the various number of processors, integrated circuits, and memory devices ((e.g., FLASH, random access memory (RAM), read only memory (ROM), electrically programmable read only memory (EPROM), electrically erasable programmable read only memory (EEPROM)) positioned within the housing. The controller(s) as disclosed also include hardware-based inputs and outputs for receiving and transmitting data, respectively from and to other hardware-based devices as discussed herein.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A system comprising:
at least one switch receiving a first direct current (DC) input signal from a first DC charging station;
at least one transformer, the at least one transformer comprising a primary side and a secondary side, the secondary side of the at least one transformer connected to the at least one switch and transferring the first DC input signal;
a first active bridge positioned on the secondary side, the first active bridge generating a DC output signal, the DC output signal supplying one or more vehicle loads, wherein the DC output signal is greater than the first DC input signal; and
at least one controller programmed to activate the at least one switch in response to receiving the first DC input signal.

2. The system of claim 1, wherein the at least one switch is coupled to a center tap of the at least one transformer.

3. The system of claim 1, wherein the DC output signal is at least two times the voltage of the first DC input signal.

4. The system of claim 1 further comprising a pulsating buffer (PB) converter interfacing with the first active bridge on the secondary side, the PB converter enabling AC to DC charging, wherein the PB converter is deactivated in response to the at least one switch receiving the first DC input signal from the first DC charging station.

5. The system of claim 1 further comprising a second active bridge positioned on the primary side of the transformer, the second active bridge, in response to at least one switch being activated and the first active bridge being activated by the at least one controller, providing a first AC output powering one or more AC based electronic devices coupled to a vehicle.

6. The system of claim 1 further comprising a second active bridge positioned on the primary side of the transformer, the second active bridge providing a first voltage signal based on an input voltage signal from a mains supply of an electrical grid.

7. The system of claim 6, wherein the at least one controller is further programmed to deactivate the at least one switch in response to receiving the input voltage signal from the mains supply.

8. The system of claim 6, wherein the first active bridge providing a second voltage signal for storage on one or more batteries in response to the first voltage signal.

9. The system of claim 8 further comprising a pulsating buffer (PB) converter to interface with the first active bridge, the PB converter modifying the second voltage signal.

10. A system comprising:
at least one switch receiving a first direct current (DC) input signal from a first DC charging station;
at least one transformer, the at least one transformer comprising a first side and a second side, the second side of the at least one transformer connected to the at least one switch and transferring the first DC input signal;
a first active bridge positioned on the second side, the first active bridge generating a DC output signal after increasing the first DC input signal, the DC output signal supplying one or more vehicle loads;
a second active bridge positioned on the first side of the transformer and providing a first AC output signal based on the first DC input signal; and
at least one controller programmed to activate the at least one switch in response to receiving the first DC input signal.

11. The system of claim 10, wherein the at least one switch is coupled to a center tap of the at least one transformer.

12. The system of claim 10, wherein the DC output signal is at least two times the voltage of the first DC input signal.

13. The system of 10 further comprising a pulsating buffer (PB) converter interfacing with the first active bridge on the second side, the PB converter enabling AC to DC charging, wherein the PB converter is deactivated in response to the at least one switch receiving the first DC input signal from the first DC charging station.

14. The system of claim 10, wherein the second active bridge, in response to at least one switch being activated and the first active bridge being activated by the at least one controller, providing the first AC output signal powering one or more AC based electronic devices coupled to a vehicle.

15. The system of claim 10, wherein the second active bridge, based on an input voltage signal from a mains supply of an electrical grid, providing a first voltage signal.

16. The system of claim 15, wherein the at least one controller is further programmed to deactivate the at least one switch in response to receiving the input voltage signal from the mains supply.

17. The system of claim 15, wherein the first active bridge, in response to the first voltage signal, providing a second voltage signal for storage on one or more batteries.

18. The system of claim 17 further comprising a pulsating buffer (PB) converter to interface with the first active bridge, the PB converter modifying the second voltage signal.

19. A system comprising:
at least one switch receiving a first direct current (DC) input signal from a first DC charging station;
at least one transformer, comprising a primary side and a secondary side, the secondary side of the at least one transformer connected to the at least one switch and transferring the first DC input signal;
a first active bridge positioned on the secondary side, the first active bridge increasing the transferred first DC input signal to generate a DC output signal, the DC output signal supplying one or more loads in a vehicle; and
a second active bridge positioned on the first side of the transformer, the second active bridge providing a first AC output and powering one or more AC based electronic devices coupled to a vehicle in response to the first active bridge generating the DC output signal.

20. The system of claim 19 further comprising at least one controller programmed to activate the at least one switch in response to receiving the first DC input signal.
